(19) United States
(12) Patent Application Publication
(10) Pub. No.: US 2022/0165118 A1
(43) Pub. Date: May 26, 2022

(54) METHOD OF MANAGING WAGER MICRO-MARKETS WITH AI USING HUMAN TRADERS AND WEIGHTED DATASETS

(71) Applicant: AdrenalineIP, Washington, DC (US)

(72) Inventors: Casey Alexander HUKE, Washington, DC (US); John CRONIN, Jericho, VT (US); Joseph W. BEYERS, Saratoga, CA (US); Michael D'ANDREA, Burlington, VT (US)

(73) Assignee: AdrenalineIP, Washington, DC (US)

(21) Appl. No.: 17/533,415

(22) Filed: Nov. 23, 2021

Related U.S. Application Data
(60) Provisional application No. 63/117,011, filed on Nov. 23, 2020.

(51) Int. Cl. G07F 17/32; G06Q 50/34

(52) U.S. Cl. CPC G07F 17/323; G06Q 50/34; G07F 17/3288; G07F 17/3211

(57) ABSTRACT

The present disclosure provides a method of managing wagering micro-markets using artificial intelligence with human skilled game operators or human traders in which a wagering network contains a historical odds database, as well as a historical database that is weighted containing the inputs or adjusted odds from the most profitable skilled game operators, SGOs, that are filtered by the situational data from the live event and correlations, are performed to extract the wagering odds that are correlated allowing the SGO to review the wagering odds and either accept or adjust the wagering odds which are presented to the users through the wagering network.

### CROSS-REFERENCE TO RELATED APPLICATIONS

The present patent application claims benefit and priority to U.S. Provisional Patent Application No. 63/117,011 entitled “METHOD OF MANAGING BET MICRO-MARKETS WITH ARTIFICIAL INTELLIGENCE USING HUMAN TRADERS” filed on Nov. 23, 2020 which is hereby incorporated by reference into the present disclosure.

### FIELD

The present disclosures are generally related to play-by-play wagering on live sporting events.

### BACKGROUND

Currently, skilled game operators (“SGOs”), do not have a method of reviewing wagering odds created by an artificial intelligence (“AI”), system.

Also, SGOs do not have the ability to have their corrections or inputted wager odds be incorporated in an AI system. An AI system may allow a combination of wager odds from the AI as well as weighted historical inputs from the SGO and may only incorporate the SGOs that are the best at adjusting the odds.

Lastly, there is no method to have the weighted combined wagering odds be reviewable and adjustable by the SGO.

Thus, there is a need in the prior art to allow skilled game operators to manage micro-markets with artificial intelligence.

### SUMMARY

Methods and systems for managing wagering markets may be provided. In one embodiment, a method of managing wagers using skilled game operators (SGOs) can include storing odds in an odds database; storing at least situational data and parameters in a skilled game operator (SGO) correction database; storing at least user ID and profit data in an SGO profit database; determining one or more SGOs with a wager success rate over a predetermined threshold; extracting at least one agent ID from the SGO profit database; extracting at least odds data and profit data from the odds database; displaying wagering odds to one or more SGOs and/or a wagering network administrator; prompting the one or more SGOs and/or the wagering network administrator to accept or adjust odds; and storing profit data and odds data in at least the SGO correction database and the SGO profit database.

In another embodiment, a system of managing wagers using skilled game operators (SGOs) can include an odds database configured to store historical odds and profit data; a skilled game operator (SGO) correction database configured to store at least situational data and parameters; an SGO profit database configured to store at least user ID and profit data; a base module configured to initiate at least an SGO scoring module, a wager correlation module, and an SGO review module; the SGO scoring module is configured to filter the SGO correction database for the most profitable SGOs, the wager correlation module is configured to correlate wager odds using at least parameters and situational data, and the SGO review module is configured to display wager odds to one or more SGOs, a wagering network administrators, and/or the wager app; and a display device configured to display at least wager odds.

### BRIEF DESCRIPTIONS OF THE DRAWINGS

The accompanying drawings illustrate various embodiments of systems, methods, and various other aspects of the embodiments. Any person with ordinary skill in the art will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1: illustrates a system for managing wager micro-markets with AI using human traders and weighted datasets, according to an embodiment.

FIG. 2: illustrates a base module, according to an embodiment.

FIG. 3: illustrates an SGO scoring module, according to an embodiment.

FIG. 4: illustrates a wager correlation module, according to an embodiment.

FIG. 5: illustrates an SGO review module, according to an embodiment.

FIG. 6: illustrates an SGO correction database, according to an embodiment.

FIG. 7: illustrates an SGO profit database, according to an embodiment.

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word exemplary means serving as an example, instance or illustration. The embodiments described herein are not limiting, but rather are exemplary only. The described embodiments are not necessarily to be construed as preferred or advantageous over other embodiments. Moreover, the terms embodiments of the invention, embodiments, or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that specific circuits can perform the various sequence of actions described herein (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in several different forms, all of which have been contemplated to be within the scope of the claimed subject matter. In addition, for each of the embodiments described herein, the corresponding form of any such embodiments may be described herein as, for example, a computer configured to perform the described action.

With respect to the embodiments, a summary of the terminology used herein is provided.

An action refers to a specific play or specific movement in a sporting event. For example, an action may determine which players were involved during a sporting event. In some embodiments, an action may be a throw, shot, pass, swing, kick, and/or hit performed by a participant in a sporting event. In some embodiments, an action may be a strategic decision made by a participant in the sporting event, such as a player, coach, management, etc. In some embodiments, an action may be a penalty, foul, or other type of infraction occurring in a sporting event. In some embodiments, an action may include the participants of the sporting event. In some embodiments, an action may include beginning events of sporting event, for example opening tips, coin flips, opening pitch, national anthem singers, etc. In some embodiments, a sporting event may be football, hockey, basketball, baseball, golf, tennis, soccer, cricket, rugby, MMA, boxing, swimming, skiing, snowboarding, horse racing, car racing, boat racing, cycling, wrestling, Olympic sport, eSports, etc. Actions can be integrated into the embodiments in a variety of manners.

A “bet” or “wager” is to risk something, usually a sum of money, against someone else's or an entity based on the outcome of a future event, such as the results of a game or event. It may be understood that non-monetary items may be the subject of a “bet” or “wager” as well, such as points or anything else that can be quantified for a “bet” or “wager.” A bettor refers to a person who bets or wagers. A bettor may also be referred to as a user, client, or participant throughout the present invention. A “bet” or “wager” could be made for obtaining or risking a coupon or some enhancements to the sporting event, such as better seats, VIP treatment, etc. A “bet” or “wager” can be made for certain amount or for a future time. A “bet” or “wager” can be made for being able to answer a question correctly. A “bet” or “wager” can be made within a certain period. A “bet” or “wager” can be integrated into the embodiments in a variety of manners.

A “book” or “sportsbook” refers to a physical establishment that accepts bets on the outcome of sporting events. A “book” or “sportsbook” system enables a human working with a computer to interact, according to set of both implicit and explicit rules, in an electronically powered domain to place bets on the outcome of sporting event. An added game refers to an event not part of the typical menu of wagering offerings, often posted as an accommodation to patrons. A “book” or “sportsbook” can be integrated into the embodiments in a variety of manners.

To “buy points” means a player pays an additional price (more money) to receive a half-point or more in the player's favor on a point spread game. Buying points means you can move a point spread, for example, up to two points in your favor. “Buy points” can be integrated into the embodiments in a variety of manners.

The “price” refers to the odds or point spread of an event. To “take the price” means betting the underdog and receiving its advantage in the point spread. “Price” can be integrated into the embodiments in a variety of manners.

“No action” means a wager in which no money is lost or won, and the original bet amount is refunded. “No action” can be integrated into the embodiments in a variety of manners.

The “sides” are the two teams or individuals participating in an event: the underdog and the favorite. The term “favorite” refers to the team considered most likely to win an event or game. The “chalk” refers to a favorite, usually a heavy favorite. Bettors who like to bet big favorites are referred to “chalk eaters” (often a derogatory term). An event or game in which the sportsbook has reduced its betting limits, usually because of weather or the uncertain status of injured players, is referred to as a “circled game.” “Laying the points or price” means betting the favorite by giving up points. The term “dog” or “underdog” refers to the team perceived to be most likely to lose an event or game. A “longshot” also refers to a team perceived to be unlikely to win an event or game. “Sides,” “favorite,” “chalk,” “circled game,” “laying the points price,” “dog,” and “underdog” can be integrated into the embodiments in a variety of manners.

The “money line” refers to the odds expressed in terms of money. With money odds, whenever there is a minus (−), the player “lays” or is “laying” that amount to win (for example, $100); where there is a plus (+), the player wins that amount for every $100 wagered. A “straight bet” refers to an individual wager on a game or event that will be determined by a point spread or money line. The term “straight-up” means winning the game without any regard to the “point spread,” a “money-line” bet. “Money line,” “straight bet,” and “straight-up” can be integrated into the embodiments in a variety of manners.

The “line” refers to the current odds or point spread on a particular event or game. The “point spread” refers to the margin of points in which the favored team must win an event by to “cover the spread.” To “cover” means winning by more than the “point spread.” A handicap of the “point spread” value is given to the favorite team so bettors can choose sides at equal odds. “Cover the spread” means that a favorite wins an event with the handicap considered or the underdog wins with additional points. To “push” refers to when the event or game ends with no winner or loser for wagering purposes, a tie for wagering purposes. A “tie” is a wager in which no money is lost or won because the teams' scores were equal to the number of points in the given “point spread.” The “opening line” means the earliest line posted for a particular sporting event or game. The term “pick” or “pick'em” refers to a game when neither team is favored in an event or game. “Line,” “cover the spread,” “cover,” “tie,” “pick,” and “pick-em” can be integrated into the embodiments in a variety of manners.

To “middle” means to win both sides of a game; wagering on the “underdog” at one point spread and the favorite at a different point spread and winning both sides. For example, if the player bets the underdog +4½ and the favorite −3½ and the favorite wins by 4, the player has middled the book and won both bets. “Middle” can be integrated into the embodiments in a variety of manners.

Digital gaming refers to any type of electronic environment that can be controlled or manipulated by a human user for entertainment purposes. A system that enables a human and a computer to interact according to set of both implicit and explicit rules in an electronically powered domain for the purpose of recreation or instruction. “eSports” refers to a form of sports competition using video games, or a multiplayer video game played competitively for spectators, typically by professional gamers. Digital gaming and “eSports” can be integrated into the embodiments in a variety of manners.

The term event refers to a form of play, sport, contest, or game, especially one played according to rules and decided by skill, strength, or luck. In some embodiments, an event may be football, hockey, basketball, baseball, golf, tennis, soccer, cricket, rugby, MMA, boxing, swimming, skiing, snowboarding, horse racing, car racing, boat racing, cycling, wrestling, Olympic sport, etc. The event can be integrated into the embodiments in a variety of manners.

The “total” is the combined number of runs, points or goals scored by both teams during the game, including overtime. The “over” refers to a sports bet in which the player wagers that the combined point total of two teams will be more than a specified total. The “under” refers to bets that the total points scored by two teams will be less than a certain figure. “Total,” “over,” and “under” can be integrated into the embodiments in a variety of manners.

A “parlay” is a single bet that links together two or more wagers; to win the bet, the player must win all the wagers in the “parlay.” If the player loses one wager, the player loses the entire bet. However, if they win all the wagers in the “parlay,” the player receives a higher payoff than if the player had placed the bets separately. A “round robin” is a series of parlays. A “teaser” is a type of parlay in which the point spread, or total of each individual play is adjusted. The price of moving the point spread (teasing) is lower payoff odds on winning wagers. “Parlay,” “round robin,” “teaser” can be integrated into the embodiments in a variety of manners.

A “prop bet” or “proposition bet” means a bet that focuses on the outcome of events within a given game. Props are often offered on marquee games of great interest. These include Sunday and Monday night pro football games, various high-profile college football games, major college bowl games, and playoff and championship games. An example of a prop bet is “Which team will score the first touchdown?” “Prop bet” or “proposition bet” can be integrated into the embodiments in a variety of manners.

A “first-half bet” refers to a bet placed on the score in the first half of the event only and only considers the first half of the game or event. The process in which you go about placing this bet is the same process that you would use to place a full game bet, but as previously mentioned, only the first half is important to a first-half bet type of wager. A “half-time bet” refers to a bet placed on scoring in the second half of a game or event only. “First-half-bet” and “half-time-bet” can be integrated into the embodiments in a variety of manners.

A “futures bet” or “future” refers to the odds that are posted well in advance on the winner of major events. Typical future bets are the Pro Football Championship, Collegiate Football Championship, the Pro Basketball Championship, the Collegiate Basketball Championship, and the Pro Baseball Championship. “Futures bet” or “future” can be integrated into the embodiments in a variety of manners.

The “listed pitchers” is specific to a baseball bet placed only if both pitchers scheduled to start a game start. If they do not, the bet is deemed “no action” and refunded. The “run line” in baseball refers to a spread used instead of the money line. “Listed pitchers,” “no action,” and “run line” can be integrated into the embodiments in a variety of manners.

The term “handle” refers to the total amount of bets taken. The term “hold” refers to the percentage the house wins. The term “juice” refers to the bookmaker's commission, most commonly the 11 to 10 bettors lay on straight point spread wagers: also known as “vigorish” or “vig”. The “limit” refers to the maximum amount accepted by the house before the odds and/or point spread are changed. “Off the board” refers to a game in which no bets are being accepted. “Handle,” “juice,” vigorish,” “vig,” and “off the board” can be integrated into the embodiments in a variety of manners.

“Casinos” are a public room or building where gambling games are played. “Racino” is a building complex or grounds having a racetrack and gambling facilities for playing slot machines, blackjack, roulette, etc. “Casino” and “Racino” can be integrated into the embodiments in a variety of manners.

Customers are companies, organizations or individuals that would deploy, for fees, and may be part of, or perform, various system elements or method steps in the embodiments.

Managed service user interface service is a service that can help customers (1) manage third parties, (2) develop the web, (3) perform data analytics, (4) connect thru application program interfaces and (4) track and report on player behaviors. A managed service user interface can be integrated into the embodiments in a variety of manners.

Managed service risk management service are services that assist customers with (1) very important person management, (2) business intelligence, and (3) reporting. These managed service risk management services can be integrated into the embodiments in a variety of manners.

Managed service compliance service is a service that helps customers manage (1) integrity monitoring, (2) play safety, (3) responsible gambling, and (4) customer service assistance. These managed service compliance services can be integrated into the embodiments in a variety of manners.

Managed service pricing and trading service is a service that helps customers with (1) official data feeds, (2) data visualization, and (3) land based on property digital signage. These managed service pricing and trading services can be integrated into the embodiments in a variety of manners.

Managed service and technology platforms are services that help customers with (1) web hosting, (2) IT support, and (3) player account platform support. These managed service and technology platform services can be integrated into the embodiments in a variety of manners.

Managed service and marketing support services are services that help customers (1) acquire and retain clients and users, (2) provide for bonusing options, and (3) develop press release content generation. These managed service and marketing support services can be integrated into the embodiments in a variety of manners.

Payment processing services are services that help customers with (1) account auditing and (2) withdrawal processing to meet standards for speed and accuracy. Further, these services can provide for integration of global and local payment methods. These payment processing services can be integrated into the embodiments in a variety of manners.

Engaging promotions allow customers to treat players to free bets, odds boosts, enhanced access, and flexible cashback to boost lifetime value. Engaging promotions can be integrated into the embodiments in a variety of manners.

“Cash out” or “pay out” or “payout” allow customers to make available, on singles bets or accumulated bets with a partial cash out where each operator can control payouts by always managing commission and availability. The “cash out” or “pay out” or “payout” can be integrated into the embodiments in a variety of manners, including both monetary and non-monetary payouts, such as points, prizes, promotional or discount codes, and the like.

“Customized betting” allows customers to have tailored personalized betting experiences with sophisticated tracking and analysis of players' behavior. “Customized betting” can be integrated into the embodiments in a variety of manners.

Kiosks are devices that offer interactions with customers, clients, and users with a wide range of modular solutions for both retail and online sports gaming. Kiosks can be integrated into the embodiments in a variety of manners.

Business Applications are an integrated suite of tools for customers to manage the everyday activities that drive sales, profit, and growth by creating and delivering actionable insights on performance to help customers to manage the sports gaming. Business Applications can be integrated into the embodiments in a variety of manners.

State-based integration allows for a given sports gambling game to be modified by states in the United States or other countries, based upon the state the player is in, mobile phone, or other geolocation identification means. State-based integration can be integrated into the embodiments in a variety of manners.

Game Configurator allows for configuration of customer operators to have the opportunity to apply various chosen or newly created business rules on the game as well as to parametrize risk management. The Game Configurator can be integrated into the embodiments in a variety of manners.

“Fantasy sports connectors” are software connectors between method steps or system elements in the embodiments that can integrate fantasy sports. Fantasy sports allow a competition in which participants select imaginary teams from among the players in a league and score points according to the actual performance of their players. For example, if a player in fantasy sports is playing at a given real-time sport, odds could be changed in the real-time sports for that player.

Software as a service (or SaaS) is a software delivery and licensing method in which software is accessed online via a subscription rather than bought and installed on individual computers. Software as a service can be integrated into the embodiments in a variety of manners.

Synchronization of screens means synchronizing bets and results between devices, such as TV and mobile, PC, and wearables. Synchronization of screens can be integrated into the embodiments in a variety of manners.

Automatic content recognition (ACR) is an identification technology that recognizes content played on a media device or present in a media file. Devices containing ACR support enable users to quickly obtain additional information about the content they see without any user-based input or search efforts. A short media clip (audio, video, or both) is selected to start the recognition. This clip could be selected from within a media file or recorded by a device. Through algorithms such as fingerprinting, information from the actual perceptual content is taken and compared to a database of reference fingerprints, where each reference fingerprint corresponds with a known recorded work. A database may contain metadata about the work and associated information, including complementary media. If the media clip's fingerprint is matched, the identification software returns the corresponding metadata to the client application. For example, during an in-play sports game, a “fumble” could be recognized and at the time stamp of the event, metadata such as “fumble” could be displayed. Automatic content recognition (ACR) can be integrated into the embodiments in a variety of manners.

Joining social media means connecting an in-play sports game bet or result to a social media connection, such as a FACEBOOK® chat interaction. Joining social media can be integrated into the embodiments in a variety of manners.

Augmented reality means a technology that superimposes a computer-generated image on a user's view of the real world, thus providing a composite view. In an example of this invention, a real time view of the game can be seen and a “bet”—which is a computer-generated data point—is placed above the player that is bet on. Augmented reality can be integrated into the embodiments in a variety of manners.

Some embodiments of this disclosure, illustrating all its features, will now be discussed in detail. It can be understood that the embodiments are intended to be open-ended in that an item or items used in the embodiments is not meant to be an exhaustive listing of such item or items or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

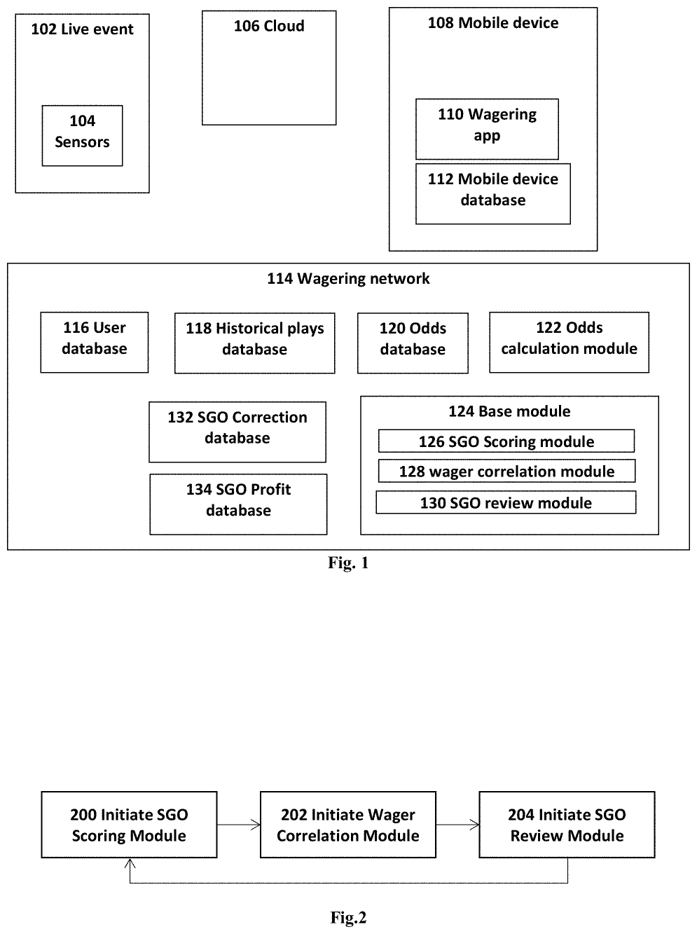

FIG. 1 is a system for managing wager micro-markets with AI using human traders and weighted datasets. This system may include a live event 102, for example, a sporting event such as a football, basketball, baseball, or hockey game, tennis match, golf tournament, eSports, or digital game, etc. The live event 102 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 102, such as the score of an American football game or the run line in a baseball game, or a series of actions in the live event 102. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 102 or at another location.

Further, embodiments may include a plurality of sensors 104 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 104 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 106 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the internet, and relies on sharing resources to achieve coherence and economies of scale, like a public utility. In contrast, third-party clouds allow organizations to focus on their core businesses instead of expending resources on computer infrastructure and maintenance. The cloud 106 may be communicatively coupled to a peer-to-peer wagering network 114, which may perform real-time analysis on the type of play and the result of the play. The cloud 106 may also be synchronized with game situational data such as the time of the game, the score, location on the field, weather conditions, and the like, which may affect the choice of play utilized. For example, in an exemplary embodiment, the cloud 106 may not receive data gathered from the sensors 104 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 108 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 108 could be an optional component and would be utilized in a situation where a paired wearable device employs the mobile device 108 for additional memory or computing power or connection to the internet.

Further, embodiments may include a wagering software application or a wagering app 110, which is a program that enables the user to place bets on individual plays in the live event 102, streams audio and video from the live event 102, and features the available wagers from the live event 102 on the mobile device 108. The wagering app 110 allows the user to interact with the wagering network 114 to place bets and provide payment/receive funds based on wager outcomes.

Further, embodiments may include a mobile device database 112 that may store some or all the user's data, the live event 102, or the user's interaction with the wagering network 114.

Further, embodiments may include the wagering network 114, which may perform real-time analysis on the type of play and the result of a play or action. The wagering network 114 (or the cloud 106) may also be synchronized with game situational data, such as the time of the game, the score, location on the field, weather conditions, and the like, which may affect the choice of play utilized. For example, in an exemplary embodiment, the wagering network 114 may not receive data gathered from the sensors 104 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 114 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 116, which may contain data relevant to all users of the wagering network 114 and may include, but is not limited to, a user ID, a device identifier, a paired device identifier, wagering history, or wallet information for the user. The user database 116 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 116 may contain betting lines and search queries. The user database 116 may be searched based on a search criterion received from the user. Each betting line may include but is not limited to, a plurality of betting attributes such as at least one of the following: the live event 102, a team, a player, an amount of wager, etc. The user database 116 may include, but is not limited to, information related to all the users involved in the live event 102. In one exemplary embodiment, the user database 116 may include information for generating a user authenticity report and a wagering verification report. Further, the user database 116 may be used to store user statistics like, but not limited to, the retention period for a particular user, frequency of wagers placed by a particular user, the average amount of wager placed by each user, etc.

Further, embodiments may include a historical plays database 118 that may contain play data for the type of sport being played in the live event 102. For example, in American Football, for optimal odds calculation, the historical play data may include metadata about the historical plays, such as time, location, weather, previous plays, opponent, physiological data, etc.

Further, embodiments may utilize an odds database 120—that contains the odds calculated by an odds calculation module 122—to display the odds on the user's mobile device 108 and take bets from the user through the mobile device wagering app 110.

Further, embodiments may include the odds calculation module 122, which may utilize historical play data to calculate odds for in-play wagers.

Further, embodiments may include a base module 124 which may initiate the SGO scoring module 126 that may determine the highest profitable SGOs, or skilled game operators, to provide a more refined dataset in the SGO correction database 132. A skilled game operator may be a human who sets or defines odds or determines the validity of odds. The base module 124 may initiate the wager correlation module 128, which may perform correlations on the data stored in the odds database 120 and SGO correction database 132. An SGO may review, accept, adjust, and offer the available wager odds via the wagering app 110. Suppose the parameters, which are the wager odds vs. the profits, are above a predetermined threshold. In that case, those odds may be sent to the SGO review module 130. An SGO may review, accept, adjust, and offer the available wager odds via the wagering app 110. If the correlation coefficient is below a predetermined threshold, then the wager odds sent to the SGO review module 130 may be from the data stored in the odds database 120, and in some embodiments may be the odds created from the odds calculation module 122. The base module 124 may initiate the SGO review module 130, which allows the SGO, to receive, review and either accept or change the wagering odds that are presented on the wagering app 110. If the data is altered, such as an input of wager odds from the SGO, the data may be stored in the SGO correction database 132.

Further, embodiments may include an SGO scoring module 126, which may filter the SGO correction database 132 for the agent ID. For example, the SGO correction database 132 may be filtered for the Agent ID JS123456 to see all the corrections inputted by that skilled game operator or agent. The SGO scoring module 126 may determine the average profitability of the agent. For example, the SGO scoring module 126 may add up all the profits corresponding to the entries with the same agent ID and then divide the total number of profits by the number of entries to determine the agent's average profit when they make an adjustment or correction. The SGO scoring module 126 may store the average profitability in the SGO profits database 134. For example, the SGO scoring module 126 may store the agent ID, such as JS123456, with an average profit of $35,000. Then it is determined if there are more SGOs in the SGO correction database 132. For example, the SGO scoring module 126 may determine if any other skilled game operators are present and determine the average profitability of agents. If more agents remain in the SGO correction database 132, the SGO scoring module 126 may filter the SGO correction database 132 for the next agent ID, and the process may return to determining the average profitability for the next agent. If there are no more agents remaining in the SGO correction database 132, the SGO scoring module 126 may sort the SGO profit database 134 by the average profitability. The SGO scoring module 126 may extract the ten lowest profitable agent IDS. For example, the SGO scoring module 126 may select the lowest average profitable agents to provide a weighted score for the process described in the wager correlation module 128, so only the best performing skilled game operators or agent's odds are used in the correlations. In some embodiments, there may be another number selected to remove the lowest profitable agents such as 5, 15, 20, etc. In some embodiments, the agents remaining may need to reach a certain profitability threshold to be selected, such as average profitability over a predetermined threshold such as $30,000 per wager adjustment. The SGO scoring module 126 may remove the data entries with extracted agent IDs. For example, any agent determined to be the lowest profitable agent may have their data entries removed from the SGO correction database 132 so that they are not used in the process described in the wager correlation module 128 thus possibly providing a more refined dataset for the correlations. The SGO scoring module 126 may return to the base module 124.

Further, embodiments may include a wager correlation module 128 that may receive the live event 102 situational data. For example, the received situational data may be the Boston Red Sox J. D. Martinez up to bat in the first inning, and with the third pitch of the at-bat. In some embodiments, the situational data received may be information related to the current state of the live event 102, such as the time within the live event 102, the teams involved, the players involved, etc. The wager correlation module 128 may filter the odds database 120 for the received situational data. For example, the odds database 120 may be filtered having the Boston Red Sox J. D. Martinez up to bat in the first inning, and with the third pitch of the at-bat and the event being J. D. Martinez hitting a single so that the remaining data are the historical wager odds for the previous situations in which J. D. Martinez hit a single on the third pitch of the at-bat. The wager correlation module 128 may extract the data from the odds database 120. For example, the extracted data may be the historical wager odds and profits from the historical instances in which J. D. Martinez hit a single on the third pitch of the at-bat. The wager correlation module 128 may filter the SGO correction database 132 for the received situational data. For example, the SGO correction database 132 may be filtered for the Boston Red Sox J. D. Martinez up to bat in the first inning, and with the third pitch of the at-bat and the event being J. D. Martinez hitting a single so that the remaining data are the historical wager odds for the previous situations in which J. D. Martinez hit a single on the third pitch of the at-bat. The wager correlation module 128 may extract the data from the SGO correction database 132. For example, the extracted data may be the historical wager odds and profits in which an SGO inputted their own wager odds for J. D. Martinez to hit a single on the third pitch of the at-bat. The wager correlation module 128 may perform correlations on the extracted data from the odds database 120 and the SGO correction database 132. For example, the extracted data may be for J. D. Martinez to hit a single in the first inning on the third pitch of the at-bat, and then correlations may be performed on the wager odds and profits for those wager odds in that situation. An example of correlated parameters may be with the wager odds vs. profits with a 0.97 correlation coefficient, and the most reoccurring data point may be extracted, for example, the wager odds being 2:1 with a profit of $20,000 and these wager odds, such as 2:1, may be sent to the SGO review module 130 for the SGO to either accept or input their own wager odds for the situation. Another example may be if the situational data has the Boston Red Sox J. D. Martinez up to bat in the first inning, and with the third pitch of the at-bat and the event being a home run. An example of the correlated data may be with the wager odds vs. profits with a correlation coefficient of 0.95, and the most reoccurring data point may be extracted, for example, the wager odds being 6:1 with a profit of $35,000 and these wager odds, such as 6:1, may be sent to the SGO review module 130 for the SGO to either accept or input their own wager odds for the situation. An example of uncorrelated data may be if the situational data was the Boston Red Sox J. D. Martinez up to bat in the first inning, with the third pitch of the at-bat of the event being a stolen base by a runner and the correlated parameters of the wager odds vs. profits with a 0.54 correlation coefficient. This may result in the correlation coefficient not being a above a predetermined threshold and the wager odds from the odds database 120, or in some embodiments the odds from the odds calculation module 122, may be sent to the SGO review module 130. The wager correlation module 128 may determine if the correlation is above a predetermined threshold, for example, above a 0.75 correlation coefficient. For example, the predetermined threshold may be a correlation coefficient of 0.90, and if the correlations are performed on the wager odds vs. profits with the same situational data, then the most reoccurring data point may be extracted. The wager odds from the data point may be sent to the SGO review module 130. If the correlation coefficient is below the 0.90 correlation coefficient, then the SGO review module 130 may receive the wager odds from the odds database 120, or in some embodiments, receive odds from the odds calculation module 122. If the correlation coefficient is above the predetermined threshold, then the wager correlation module 128 may extract the most reoccurring data point. For example, the predetermined threshold may be a correlation coefficient of 0.90, and if the correlations are performed on the wager odds vs. profits with the same situational data, then the most reoccurring data point may be extracted, and the wager odds from the data point may be sent to the SGO review module 130. The wager correlation module 128 may send the wager odds to the SGO review module 130. For example, the wager odds that may be sent may be odds at 2:1 that Boston Red Sox J. D. Martinez is up to bat in the first inning, with the third pitch of the at-bat and the event being a single. If the correlation coefficient is below the predetermined threshold, then the wager correlation module 128 may send the wager odds from the odds database 120 to the SGO review module 130. In some embodiments, the wager odds sent may be the wager odds calculated in the odds calculation module 122. The wager correlation module 128 may return to the base module 124.

Further, embodiments may include an SGO review module 130, which may continuously poll for wager odds from the wager correlation module 128. For example, the SGO review module 130 may receive the wager odds for the SGO to review. The SGO review module 130 may receive the wager odds from the wager correlation module 128. For example, the wager odds for Boston Red Sox J. D. Martinez hitting a single in the first inning on the third pitch may be 2:1. The SGO review module 130 may display the wager odds to the SGO. For example, the wager odds of 2:1 for Boston Red Sox J. D. Martinez to hit a single in the first inning on the third pitch may be displayed to the SGO. The SGO review module 130 may determine if the SGO accepted the wager odds. For example, the SGO may accept the 2:1 wager odds, or the SGO may disagree with the presented wager odds and input their wager odds. If the SGO accepted the wager odds, then the wager odds may be offered on the wagering app 110. If the SGO did not accept the wager odds, then the SGO may input the new wager odds. For example, the SGO may adjust the wager odds from 2:1 to 3:1. The SGO review module 130 may offer the inputted wager odds on the wagering app 110. The SGO review module 130 may store the new odds in the SGO correction database 132. For example, the SGO correction database 132 may store the situational data such as the team being the Boston Red Sox, the player being J. D. Martinez, the inning being the 1st, the pitch being the 3rd, the event is to hit a single, and the wager odds being 3:1. The SGO review module 130 may return to the base module 124.

Further, embodiments may include an SGO correction database 132, which may be created from the process described in the SGO review module 130 in which when an SGO may input new wager odds for a wager the situational data from the event and the wager as well as profits from that wager are stored in the SGO correction database 132. The SGO correction database 132 may contain the situational data, such as the action ID, the team, the player, the inning, or the time of the event, the pitch number, and the event, as well the parameters such as the agent ID, the wager odds, and the profit amount.

Further, embodiments may include an SGO profit database 134, which may be created in the process described in the SGO scoring module 126 in which the average profits for each skilled game operator or agent may be determined and stored in the SGO profit database 134 to determine the highest and lowest profitable skilled game operators or agents. The SGO profit database 134 may contain the agent ID, such as JS123456, and the average profit, such as $35,000. The SGO profit database 134 may rank the skilled game operators or agents from 1 to “n,” representing an infinite number of agents possible in some embodiments.

FIG. 2 illustrates the base module 124. The process may begin with the base module 124 initiating, at step 200, the SGO scoring module 126. For example, the SGO scoring module 126 may filter the SGO correction database 132 for the agent ID. For example, the SGO correction database 132 may be filtered for the Agent ID JS123456 to see all the corrections inputted by that skilled game operator or agent. The SGO scoring module 126 may determine the average profitability of the agent. For example, the SGO scoring module 126 may add up all the profits corresponding to the entries with the same agent ID and divide the total number of profits by the number of entries to determine the agent's average profit when they make an adjustment or correction. The SGO scoring module 126 may store the average profitability in the SGO profits database 134. For example, the SGO scoring module 126 may store the agent ID, such as JS123456, with an average profit of $35,000. The SGO scoring module 126 may determine if there are more SGOs in the SGO correction database 132. For example, the SGO scoring module 126 may determine if there are any other skilled game operators or agents who need their average profitability determined. If more agents remain in the SGO correction database 132, the SGO scoring module 126 may filter the SGO correction database 132 for the next agent ID, and the process may return to determining the average profitability for the next agent. If there are no more agents remaining in the SGO correction database 132, the SGO scoring module 126 may sort the SGO profit database 134 by the average profitability. The SGO scoring module 126 may extract the ten lowest profitable agent IDS. For example, the SGO scoring module 126 may select the lowest average profitable agents to provide a weighted score for the process described in the wager correlation module 128, so only the best performing skilled game operators or agent's odds are used in the correlations. In some embodiments, there may be another number selected to remove the lowest profitable agents such as 5, 15, 20, etc. In some embodiments, the agents remaining may need to reach a certain profitability threshold to be selected, such as average profitability over a predetermined threshold such as $30,000 per wager adjustment. The SGO scoring module 126 may remove the data entries with extracted agent IDs. For example, any agent determined to be the lowest profitable agents may have their data entries removed from the SGO correction database 132 so that they are not used in the process described in the wager correlation module 128 to provide a more refined dataset for the correlations. The SGO scoring module 126 may return to the base module 124. The base module 124 may initiate, at step 202, the wager correlation module 128. For example, the wager correlation module 128 may receive the situational data from the live event 102. For example, the received situational data may be the Boston Red Sox J. D. Martinez up to bat in the first inning, and the third pitch of the at-bat. In some embodiments, the situational data received may be information related to the current state of the live event 102, such as the time within the live event 102, the teams involved, the players involved, etc. The wager correlation module 128 may filter the odds database 120 for the received situational data. For example, the odds database 120 may be filtered for the Boston Red Sox J. D. Martinez up to bat in the first inning, and with the third pitch of the at-bat and the event being J. D. Martinez hitting a single so that the remaining data are the historical wager odds for the previous situations in which J. D. Martinez hit a single on the third pitch of the at-bat. The wager correlation module 128 may extract the data from the odds database 120. For example, the extracted data may be the historical wager odds and profits from the historical instances in which J. D. Martinez hit a single on the third pitch of the at-bat. The wager correlation module 128 may filter the SGO correction database 132 for the received situational data. For example, the SGO correction database 132 may be filtered for the Boston Red Sox J. D. Martinez up to bat in the first inning, with the third pitch of the at-bat and the event being J. D. Martinez hitting a single so that the remaining data are the historical wager odds for the previous situations in which J. D. Martinez hit a single on the third pitch of the at-bat. The wager correlation module 128 may extract the data from the SGO correction database 132. For example, the extracted data may be the historical wager odds and profits in which an SGO inputted their own wager odds for J. D. Martinez to hit a single on the third pitch of the at-bat. The wager correlation module 128 may perform correlations on the extracted data from the odds database 120 and the SGO correction database 132. For example, the extracted data may be for J. D. Martinez to hit a single in the first inning on the third pitch of the at-bat, and then correlations may be performed on the wager odds and profits for those wager odds in that situation. An example of correlated parameters may be with the wager odds vs. profits with a 0.97 correlation coefficient, and the most reoccurring data point may be extracted, for example, the wager odds being 2:1 with a profit of $20,000 and these wager odds, such as 2:1, may be sent to the SGO review module 130 for the SGO to either accept or input their own wager odds for the situation. Another example may be if the situational data is the Boston Red Sox J. D. Martinez up to bat in the first inning, and with the third pitch of the at-bat and the event being a home run. An example of the correlated data may be with the wager odds vs. profits with a correlation coefficient of 0.95, and the most reoccurring data point may be extracted, for example, the wager odds being 6:1 with a profit of $35,000 and these wager odds, such as 6:1, may be sent to the SGO review module 130 for the SGO to either accept or input their own wager odds for the situation. An example of uncorrelated data may be if the situational data was the Boston Red Sox J. D. Martinez up to bat in the first inning, with the third pitch of the at-bat and the event being a stolen base by a runner and the correlated parameters of the wager odds vs. profits with a 0.54 correlation coefficient. This may result in the correlation coefficient not being a above a predetermined threshold and the wager odds from the odds database 120, or in some embodiments the odds from the odds calculation module 122, may be sent to the SGO review module 130. The wager correlation module 128 may determine if the correlation is above a predetermined threshold, for example, above a 0.75 correlation coefficient. For example, the predetermined threshold may be a correlation coefficient of 0.90, and if the correlations are performed on the wager odds vs. profits with the same situational data, then the most reoccurring data point may be extracted. The wager odds from the data point may be sent to the SGO review module 130. If the correlation coefficient is below the 0.90 correlation coefficient, then the SGO review module 130 may receive the wager odds from the odds database 120, or in some embodiments, receive odds from the odds calculation module 122. If the correlation coefficient is above the predetermined threshold, then the wager correlation module 128 may extract the most reoccurring data point. For example, the predetermined threshold may be a correlation coefficient of 0.90, and if the correlations are performed on the wager odds vs. profits with the same situational data, then the most reoccurring data point may be extracted, and the wager odds from the data point may be sent to the SGO review module 130. The wager correlation module 128 may send the wager odds to the SGO review module 130. For example, the wager odds that may be sent may be odds at 2:1 that Boston Red Sox J. D. Martinez up to bat in the first inning, and with the third pitch of the at-bat and the event being J. D. Martinez hitting a single. If the correlation coefficient is below the predetermined threshold, then the wager correlation module 128 may send the wager odds from the odds database 120 to the SGO review module 130. In some embodiments, the wager odds may be the wager odds calculated in the odds calculation module 122. The wager correlation module 128 may return to the base module 124. The base module 124 may initiate, at step 204, the SGO review module 130. For example, the SGO review module 130 may continuously poll for wager odds from the wager correlation module 128. For example, the SGO review module 130 may receive the wager odds for the SGO to review. The SGO review module 130 may receive the wager odds from the wager correlation module 128. For example, the wager odds for Boston Red Sox J. D. Martinez hitting a single in the first inning on the third pitch may be 2:1. The SGO review module 130 may display the wager odds to the SGO. For example, the wager odds of 2:1 for Boston Red Sox J. D. Martinez hitting a single in the first inning on the third pitch may be displayed to the SGO. The SGO review module 130 may determine if the SGO accepted the wager odds. For example, the SGO may accept the 2:1 wager odds, or the SGO may disagree with the presented wager odds and input their wager odds. If the SGO accepted the wager odds, then the wager odds may be offered on the wagering app 110. If the SGO did not accept the wager odds, then the SGO may input the new wager odds. For example, the SGO may adjust the wager odds from 2:1 to 3:1. The SGO review module 130 may offer the inputted wager odds on the wagering app 110. The SGO review module 130 may store the new odds in the SGO correction database 132. For example, the SGO correction database 132 may store the situational data such as the team being the Boston Red Sox, the player being J. D. Martinez, the inning being the 1st, the pitch being the 3rd, the event is to hit a single, and the wager odds being 3:1. The SGO review module 130 may return to the base module 124.

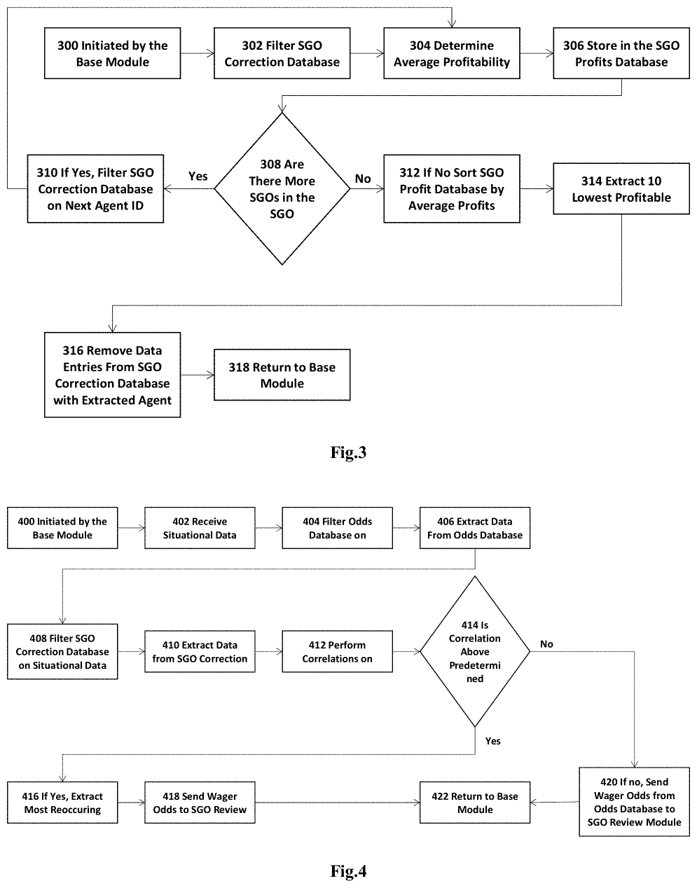

FIG. 3 illustrates the SGO scoring module 126. The process may begin with the SGO scoring module 126 being initiated, at step 300, by the base module 124. The SGO scoring module 126 may filter, at step 302, the SGO correction database 132 for the agent ID. For example, the SGO correction database 132 may be filtered for the Agent ID JS123456 to see all the corrections inputted by that skilled game operator or agent. The SGO scoring module 126 may determine, at step 304, the average profitability of the agent. For example, the SGO scoring module 126 may add up all the profits corresponding to the entries with the same agent ID and then divide the total number of profits by the number of entries to determine the agent's average profit when they make an adjustment or correction. The SGO scoring module 126 may store, at step 306, the average profitability in the SGO profits database 134. For example, the SGO scoring module 126 may store the agent ID, such as JS123456, with an average profit of $35,000. The SGO scoring module 126 may determine, at step 308, if more SGOs in the SGO correction database 132. For example, the SGO scoring module 126 may determine if any other skilled game operators or agents need their average profitability determined. If more agents remain in the SGO correction database 132, the SGO scoring module 126 may filter, at step 310, the SGO correction database 132 for the next agent ID, and the process may return to step 304. If there are no more agents remaining in the SGO correction database 132, the SGO scoring module 126 may sort, at step 312, the SGO profit database 134 by the average profitability. The SGO scoring module 126 may extract, at step 314, the ten lowest profitable agent IDS. For example, the SGO scoring module 126 may select the lowest average profitable agents to provide a weighted score for the process described in the wager correlation module 128, so only the best performing skilled game operators or agent's odds are used in the correlations. In some embodiments, there may be another number selected to remove the lowest profitable agents such as 5, 15, 20, etc. In some embodiments, the agents remaining may need to reach a certain profitability threshold to be selected, such as average profitability over a predetermined threshold such as $30,000 per wager adjustment. The SGO scoring module 126 may remove, at step 316, the data entries with extracted agent IDs. For example, any agent determined to be the lowest profitable agents may have their data entries removed from the SGO correction database 132 so that they are not used in the process described in the wager correlation module 128 to provide a more refined dataset for the correlations. The SGO scoring module 126 may return, at step 318, to the base module 124.

FIG. 4 illustrates the wager correlation module 128. The process may begin with the wager correlation module 128 being initiated, at step 400, by the base module 124. The wager correlation module 128 may receive, at step 402, the situational data from the live event 102. For example, the received situational data may be the Boston Red Sox J. D. Martinez up to bat in the first inning, and with the third pitch of the at-bat. In some embodiments, the situational data received may be information related to the current state of the live event 102, such as the time within the live event 102, the teams involved, the players involved, etc. The wager correlation module 128 may filter, at step 404, the odds database 120 for the received situational data. For example, the odds database 120 may be filtered having the Boston Red Sox J. D. Martinez up to bat in the first inning, with the third pitch of the at-bat and the event being J. D. Martinez hitting a single so that the remaining data are the historical wager odds for the previous situations in which J. D. Martinez hit a single on the third pitch of the at-bat. The wager correlation module 128 may extract, at step 406, the data from the odds database 120. For example, the extracted data may be the historical wager odds and profits from the historical instances in which J. D. Martinez hit a single on the third pitch of the at-bat. The wager correlation module 128 may filter, at step 408, the SGO correction database 132 for the received situational data. For example, the SGO correction database 132 may be filtered having the Boston Red Sox J. D. Martinez up to bat in the first inning, with the third pitch of the at-bat and the event being J. D. Martinez hitting a single so that the remaining data are the historical wager odds for the previous situations in which J. D. Martinez hit a single on the third pitch of the at-bat. The wager correlation module 128 may extract, at step 410, the data from the SGO correction database 132. For example, the extracted data may be the historical wager odds and/or profits in which an SGO inputted their own wager odds for J. D. Martinez to hit a single on the third pitch of the at-bat. The wager correlation module 128 may perform, at step 412, correlations on the extracted data from the odds database 120 and the SGO correction database 132. For example, the extracted data may be for J. D. Martinez to hit a single in the first inning on the third pitch of the at-bat, and then correlations may be performed on the wager odds and profits for those wager odds in that situation. An example of correlated parameters may be with the wager odds vs. profits with a 0.97 correlation coefficient, and the most reoccurring data point may be extracted, for example, the wager odds being 2:1 with a profit of $20,000 and these wager odds, such as 2:1, may be sent to the SGO review module 130 for the SGO to either accept or input their own wager odds for the situation. Another example may be if the situational data is the Boston Red Sox J. D. Martinez up to bat in the first inning, and with the third pitch of the at-bat and the event being a home run. An example of the correlated data may be the wager odds vs. profits with a correlation coefficient of 0.95, and the most reoccurring data point may be extracted. For example, the wager odds being 6:1 with a profit of $35,000 and these wager odds, such as 6:1, may be sent to the SGO review module 130 for the SGO to either accept or input their own wager odds for the situation. An example of uncorrelated data may be in if the situational data was the Boston Red Sox J. D. Martinez up to bat in the first inning and with the third pitch of the at-bat and the event being a stolen base by a runner and the correlated parameters of the wager odds vs. profits with a 0.54 correlation coefficient. This may result in the correlation coefficient not being a above a predetermined threshold and the wager odds from the odds database 120, or in some embodiments the odds from the odds calculation module 122, may be sent to the SGO review module 130. The wager correlation module 128 may determine, at step 414, if the correlation is above a predetermined threshold, for example, above a 0.75 correlation coefficient. For example, the predetermined threshold may be a correlation coefficient of 0.90, and if the correlations are performed on the wager odds vs. profits with the same situational data, then the most reoccurring data point may be extracted. The wager odds from the data point are sent to the SGO review module 130. If the correlation coefficient is below the 0.90 correlation coefficient, then the SGO review module 130 will receive the wager odds from the odds database 120, or in some embodiments, receive odds from the odds calculation module 122. If the correlation coefficient is above the predetermined threshold, then the wager correlation module 128 may extract, at step 416, the most reoccurring data point. For example, the predetermined threshold may be a correlation coefficient of 0.90, and if the correlations are performed on the wager odds vs. profits with the same situational data, then the most reoccurring data point may be extracted, and the wager odds from the data point may be sent to the SGO review module 130. The wager correlation module 128 may send, at step 418, the wager odds to the SGO review module 130. For example, the wager odds that may be sent may be odds at 2:1 that Boston Red Sox J. D. Martinez up to bat in the first inning, and the third pitch of the at-bat and the event being a single. If the correlation coefficient is below the predetermined threshold, then the wager correlation module 128 may send, at step 420, the wager odds from the odds database 120 to the SGO review module 130. In some embodiments, the wager odds may be the wager odds calculated in the odds calculation module 122. The wager correlation module 128 may return, at step 422, to the base module 124.

FIG. 5 illustrates the SGO review module 130. The process may begin with the SGO review module 130 being initiated, at step 500, by the base module 124. The SGO review module 130 may continuously poll, at step 502, for wager odds from the wager correlation module 128. For example, the SGO review module 130 may receive the wager odds for the SGO to review. The SGO review module 130 may receive, at step 504, the wager odds from the wager correlation module 128. For example, the wager odds for Boston Red Sox J. D. Martinez hitting a single in the first inning on the third pitch may be 2:1. The SGO review module 130 may display, at step 506, the wager odds to the SGO. For example, the wager odds of 2:1 for Boston Red Sox J. D. Martinez to hit a single in the first inning on the third pitch may be displayed to the SGO. The SGO review module 130 may determine, at step 508, if the SGO accepted the wager odds. For example, the SGO may accept the 2:1 wager odds, or the SGO may disagree with the presented wager odds and input their wager odds. If the SGO accepted the wager odds, then the wager odds may be offered, at step 510, on the wagering app 110 and may skip to step 518. If the SGO did not accept the wager odds, then the SGO may input, at step 512, the new wager odds. For example, the SGO may adjust the wager odds from 2:1 to 3:1. The SGO review module 130 may offer, at step 514, the inputted wager odds on the wagering app 110. The SGO review module 130 may store, at step 516, the new odds in the SGO correction database 132. For example, the SGO correction database 132 may store the situational data such as the team being the Boston Red Sox, the player being J. D. Martinez, the inning being the 1st, the pitch being the 3rd, the event is to hit a single, and the wager odds being 3:1. The SGO review module 130 may return, at step 518, to the base module 124.

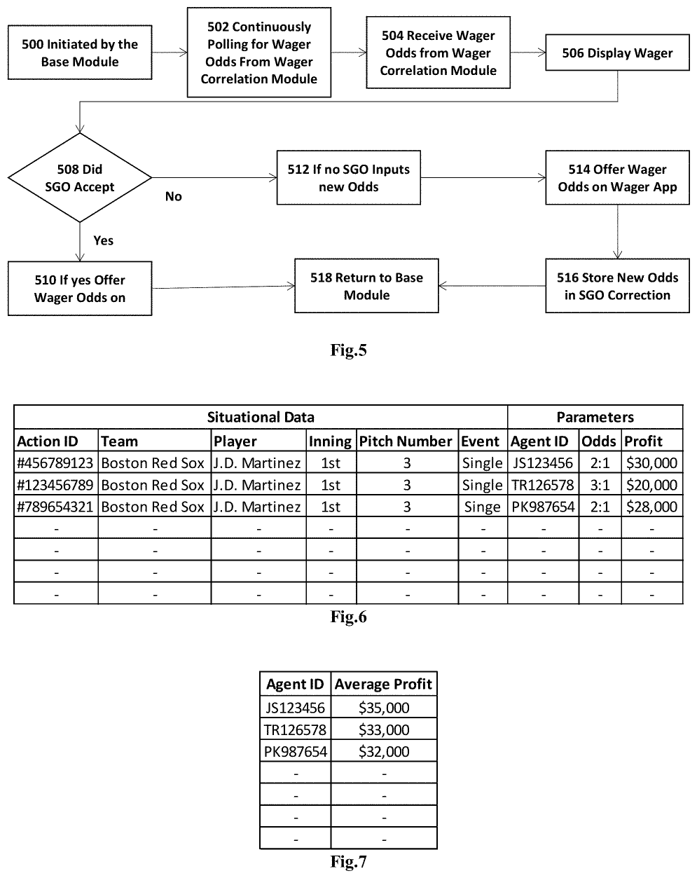

FIG. 6 illustrates the SGO correction database 132. The SGO correction database 132 may be created from the process described in the SGO review module 130, in which when an SGO may input new wager odds for a wager, the situational data from the event and the wager as well as profits from that wager are stored in the SGO correction database 132. The SGO correction database 132 may contain the situational data, such as the action ID, the team, the player, the inning, time of the event, the pitch number, the event. The SGO correction database 132 may also store the parameters such as the agent ID, the wager odds, and the profit amount.

FIG. 7 illustrates the SGO profit database 134. The SGO profit database 134 may be created in the process described in the SGO scoring module 126, in which the average profits for each skilled game operator or agent may be determined and stored in the SGO profit database 134 to determine the highest and lowest profitable skilled game operators or agents. The SGO profit database 134 may contain the agent ID, such as JS123456, and the average profit, such as $35,000. In some embodiments, the SGO profit database 134 may rank the skilled game operators or agents from 1 to “n,” representing an infinite number of agents possible.

The foregoing description and accompanying figures illustrate the principles, preferred embodiments, and modes of operation of the invention. However, the invention should not be construed as being limited to the embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of managing wagers using skilled game operators (SGOs), comprising:
storing odds in an odds database;
storing at least situational data and parameters in a skilled game operator (SGO) correction database;
storing at least user ID and profit data in an SGO profit database;
determining one or more SGOs with a wager success rate over a predetermined threshold;
extracting at least one agent ID from the SGO profit database;
extracting at least odds data and profit data from the odds database;
displaying wagering odds to one or more SGOs and/or a wagering network administrator;
prompting the one or more SGOs and/or the wagering network administrator to accept or adjust odds; and
storing profit data and odds data in at least the SGO correction database and the SGO profit database.

2. The method of managing wagers using skilled game operators (SGOs), of claim 1,
wherein a success rate is related to a winning percentage over a threshold value or a profit amount of an SGO.

3. The method of managing wagers using skilled game operators (SGOs), of claim 1, further comprising determining profitability of the SGOs with an SGO scoring module by adding up all corresponding profits of the SGO and dividing by the number of profits of the SGO.

4. The method of managing wagers using skilled game operators (SGOs), of claim 3, further comprising sorting, with the SGO scoring module, and extracting, with the SGO scoring module, at least one least profitable SGO using a predetermined number, weighted score, or profitability threshold.

5. The method of managing wagers using skilled game operators (SGOs), of claim 4, further comprising removing at least one extracted SGO.

6. The method of managing wagers using skilled game operators (SGOs), of claim 1, further comprising receiving situational data from a live event by a wager correlation module, comparing, by the wager correlation module, the data to the odds database, and extracting, by the wager correlation module, historical wager odds data and profit data from the odds database.

7. The method of managing wagers using skilled game operators (SGOs), of claim 1, further comprising receiving, by a wager correlation module, situational data from a live event, comparing, by the wager correlation module, the data the SGO correction database, and extracting, by the wager correlation module, historical wager odds data and profit data from the SGO correction database.

8. The method of managing wagers using skilled game operators (SGOs), of claim 1, further comprising determining, by a wager correlation module, correlations between the extracted data from the odds database and the extracted data from the SGO correction database.

9. The method of managing wagers using skilled game operators (SGOs), of claim 8, further comprising sending the data from at least one odds database and SGO correction database to the SGO review module.

10. The method of managing wagers using skilled game operators (SGOs), of claim 1, further comprising receiving, by an SGO review module, data from a wager correlation module and displaying the wager to the SGO or wagering network administrator.

11. The method of managing wagers using skilled game operators (SGOs), of claim 10, further comprising allowing the SGO or wagering network administrator to accept or reject the wager odds and display the odds on a wager app.

12. The method of managing wagers using skilled game operators (SGOs), of claim 11, further comprising proposing new wager odds which are stored in the SGO correction database if the SGO or wagering network administrator rejects the displayed odds.

13. The method of managing wagers using skilled game operators (SGOs), of claim 1, wherein the data extracted from a database is at least one situational, parameter, user ID, profit, or odds data.

14. A system of managing wagers using skilled game operators (SGOs), comprising:
an odds database configured to store historical odds and profit data;
a skilled game operator (SGO) correction database configured to store at least situational data and parameters;
an SGO profit database configured to store at least user ID and profit data;
a base module configured to initiate at least an SGO scoring module, a wager correlation module, and an SGO review module;
the SGO scoring module is configured to filter the SGO correction database for the most profitable SGOs, the wager correlation module is configured to correlate wager odds using at least parameters and situational data, and the SGO review module is configured to display wager odds to one or more SGOs, a wagering network administrators, and/or the wager app; and
a display device configured to display at least wager odds.

15. A system of managing wagers using skilled game operators (SGOs), of claim 14, wherein the SGO review module is further configured to allow at least one SGO or a wagering network administrator to accept wager odds or reject and propose new wager odds.

16. A system of managing wagers using skilled game operators (SGOs), of claim 15, wherein the SGO review module is further configured to store newly proposed wager odds in the SGO correction database.

17. A system of managing wagers using skilled game operators (SGOs), of claim 14, wherein the device is further configured to display at least wager odds via a notification.
